(19) United States
(12) Patent Application Publication
(10) Pub. No.: US 2024/0382882 A1
(43) Pub. Date: Nov. 21, 2024

(54) COMMERCIAL KITCHEN GREASE FILTER WITH IMPROVED GREASE TRAPPING

(71) Applicant: John Martin O’Donovan, County cork (IE)

(72) Inventor: John Martin O’Donovan, County cork (IE)

(21) Appl. No.: 18/785,261

(22) Filed: Jul. 26, 2024

Related U.S. Application Data
(63) Continuation of application No. PCT/US23/11828, filed on Jan. 30, 2023.
(60) Provisional application No. 63/304,324, filed on Jan. 28, 2022.

(51) Int. Cl. B01D 45/08; B01D 46/00; B01D 50/20

(52) U.S. Cl. CPC B01D 45/08; B01D 46/0005; B01D 50/20

(57) ABSTRACT

A grease filter assembly traps more than 90% of grease from cooking activities entrained in air, and may be used in commercial range hoods. An exemplary grease filter assembly comprises a housing, an intake baffle assembly, and an exhaust trap baffle assembly. The housing is configured to house and support the intake baffle assembly and exhaust trap baffle assembly to form a single grease filter assembly. The intake baffle assembly includes air-splitting and air-redirecting baffles configured to work in tandem as a first stage. The exhaust trap baffle assembly includes a diverter array and a spacer array that forms a second stage. Exhaust air is thus directed through a tightly-defined serpentine-shaped region in the first stage and around the air-diverting baffle array in the second stage to cause increases in air stream speeds, turbulence and/or resulting pressure drops that greatly increase removal of grease from exhaust air.

### CROSS-REFERENCE TO RELATED APPLICATION

This application claims the benefit of priority under 35 U.S.C. § 119 (e) of U.S. Provisional Patent Application No. 63/304,324, filed Jan. 28, 2022, the entire disclosure of which is hereby incorporated herein by reference.

### FIELD OF THE INVENTION

The present invention relates generally to the field of grease filters for commercial kitchens, and more specifically to an improved filter for trapping grease aerosols, carbon and other contaminants from cooking activities.

### DISCUSSION OF RELATED ART

Commercial or institutional kitchens generally include cook stoves, hot plates, deep fat fryers, and other cooking devices that produce heat energy and particulates, i.e., grease. The extreme heat and particulates must be exhausted to atmosphere usually through flue chimneys or similar venting devices for the safety and comfort of the kitchen workers.

It is commonplace in commercial kitchen for the exhausted air to be filtered, to remove the generated particulates, which commonly include grease that can eventually cause malfunction of air ventilation systems, which may create fire hazards. Accordingly, grease filters located in flume hoods positioned over cooking surfaces must be cleaned and/or replaced often, which is time-consuming and expensive.

Certain existing venting and filtering systems have employed heat exchangers to capture thermal energy from the hot gases. For example, some systems have employed a heat exchanger positioned downstream of or otherwise combined with a grease filter. Some exemplary such devices are shown in U.S. Pat. Nos. 5,456,244, 5,687,707, 6,543,526, 8,728,189, 9,182,131, 9,726,381 and 10,386,076, for example. Various configurations have been developed, mainly to improve heat exchange efficiency and/or to avoid problems associated with grease management relative to heat exchange cooling fins.

Applicant has found that while some of those designs may or may not have provided adequate heat exchanger functionality, they nevertheless have been found to provide inadequate air filtration and grease trapping functionality.

What is needed is an air filtration device of simplified construction that provides more effective grease trapping functionality than existing air filtration and air filtration/heat exchanger devices.

### SUMMARY

The present invention provides a grease filter device for trapping grease from cooking activities with improved effectiveness. The grease filter assembly is configured to vent exhaust air while removing and/or collecting grease entrained in the exhaust air from cooking activities, etc. An exemplary grease filter assembly comprises a housing, an intake baffle assembly, and an exhaust trap baffle assembly. The housing is configured to house and support the intake baffle assembly and exhaust trap baffle assembly to form a single grease filter assembly. The intake baffle assembly and exhaust trap baffle assembly are configured to work in tandem to direct the exhaust air through the grease filter assembly in a particular manner providing highly effective grease separation and capture, e.g., to remove more than 90%, or approximately 94%-99%, of air-entrained grease.

The intake baffle assembly includes a first baffle array and a second baffle array. The first baffle array includes a plurality of spaced air-splitting baffles having outer/leading surfaces that are generally convex in shape. The second baffle array includes a plurality of spaced air-redirecting baffles that have inner/leading surfaces that are generally concave in shape. The tightly-defined serpentine-shaped region defined by the first and second baffle arrays and/or the nesting/overlapping of the baffles is believed to cause an increase in air stream speed and a resulting pressure drop that greatly increases removal of grease entrained in the exhaust air as the exhaust air passes through the air intake baffle. The intake air baffle assembly serves as a first stage of a multi-stage grease filtering/grease trapping arrangement of the grease filter assembly.

An exhaust trap baffle assembly serves as a second stage of the multi-stage grease filtering/grease trapping arrangement of the grease filter assembly. More particularly, the exhaust trap baffle assembly includes a diverter array and a spacer array. The diverter array includes a plurality of spaced air-diverting baffles having outer/leading surfaces that are generally convex in shape. The exhaust trap baffle assembly also includes a spacer array that includes spacers elongated in the direction of flow of the exhaust air. A region defined between the second baffle array and the air-diverting baffle array and/or the nesting/overlapping of the baffles is believed to cause an increase in air stream speed and a resulting a pressure drop that greatly increases removal of grease entrained in the exhaust air as the exhaust air passes through the air exhaust baffle.

Exhaust air is thus directed through a tightly-defined serpentine-shaped region in the first stage and around the air-diverting baffle array in the second stage to cause increases in air stream speeds, turbulence and/or resulting pressure drops that greatly increase removal of grease from exhaust air.

### BRIEF DESCRIPTION OF THE FIGURES

An understanding of the following description will be facilitated by reference to the attached drawings, in which:

FIG. 1 is a front view of a grease filter assembly device in accordance with an exemplary embodiment of the present invention;

FIG. 2 is a rear view of the grease filter device of FIG. 1;

FIG. 3 is an exploded perspective view of the grease filter device of FIG. 1, showing a frame, an intake baffle assembly, and an exhaust trap assembly;

FIG. 4 is a top view of the exhaust trap assembly of FIG. 3;

FIG. 5 is a cross-sectional end view of the grease filter device of FIG. 1, with the frame omitted for illustrative clarity;

FIG. 6 is a partial cutaway view of a grease filtering system including the grease filter device of FIGS. 1-6, in accordance with an exemplary embodiment of the present invention; and

FIG. 7 is an end view of the grease filter device of FIG. 1.

### DETAILED DESCRIPTION

The present invention provides a grease filter device for trapping grease from cooking activities with improved effectiveness. An exemplary embodiment of the present invention is discussed below for illustrative purposes.

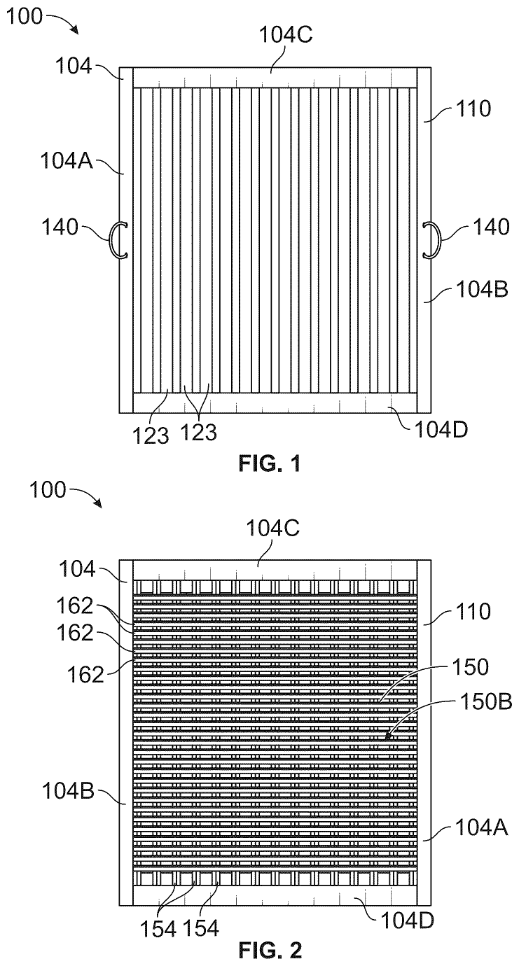

FIGS. 1-3 show a grease filter assembly 100 according to an exemplary embodiment of the present invention. The grease filter assembly 100 is configured to move exhaust air (which may be, for example, exhaust air) from one volume (e.g., a commercial kitchen room) to another volume (e.g., an environmental atmosphere outside of the room) while removing and/or collecting (collectively, “trapping”) grease entrained in the exhaust air from cooking activities, etc. In some embodiments, the grease filter assembly 100 may be dimensioned for receipt within an exhaust hood, such as a commercial kitchen exhaust hood, though it will be appreciated that the grease filter assembly 100 may be used in other contexts and in other suitable configurations.

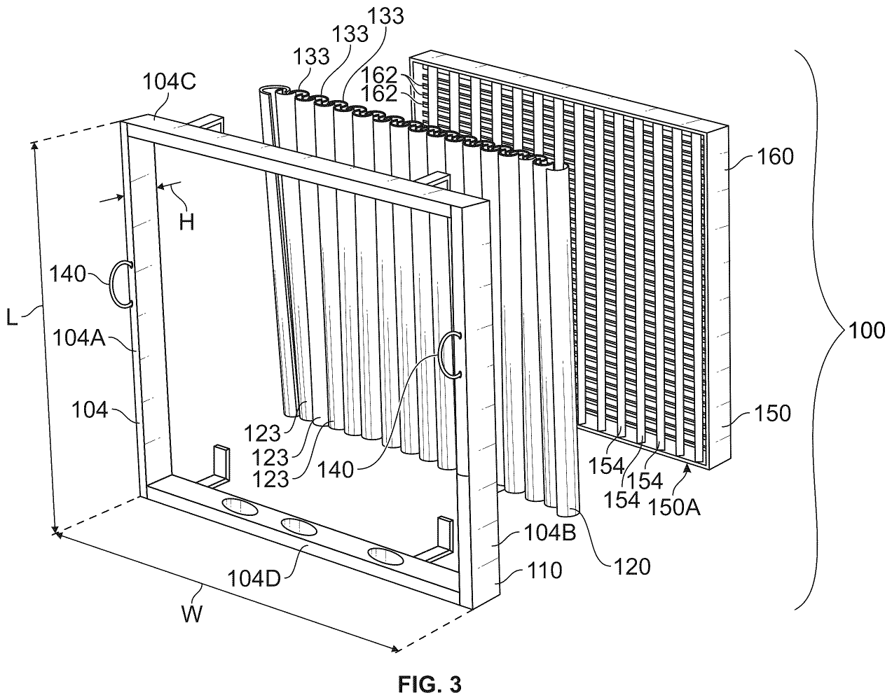

An exemplary grease filter assembly 100 comprises a housing 110, an intake baffle assembly 120, and an exhaust trap baffle assembly 150. The housing 110 is configured to house and support the intake baffle assembly 120 and exhaust trap baffle assembly 150 to form a single grease filter assembly 100. FIGS. 1 and 2 show the intake baffle assembly 120 and exhaust trap baffle assembly 150 as supported in the housing 110. FIG. 3 shows an exploded view of the intake baffle assembly 120, exhaust trap baffle assembly 150 and housing 110.

In the exemplary embodiment, a pair of opposed handles 140 is affixed to portions of the housing 110 to facilitate balanced insertion and removal of the grease filter assembly 100 into/from a commercial range hood, as a unit. Each of the pair of handles 140 may be a full or partial loop handle that may be formed integrally with or be coupled to the housing.

The intake baffle assembly 120 and exhaust trap baffle assembly 150 are configured to work in tandem to direct the exhaust air through the grease filter assembly 100 in a particular manner providing highly effective grease separation (from the exhaust air) and grease capture, as discussed in greater detail below.

The housing 110 includes a frame 104 comprising a first sidewall 104A opposite a second sidewall 104B and a third sidewall 104C opposite a fourth sidewall 104D. The third sidewall 104C and the fourth sidewall 104D are perpendicular to the first sidewall 104A and the second sidewall 104B, as best shown in FIG. 3. Various shapes of the frame 104 are contemplated, although a generally planar, rectilinear shape is shown, which may facilitate manufacture and installation. In addition, such a shape is easily adaptable to be utilized with filter assembly units or exhaust hoods that are presently commonly provided in commercial cooking settings. The shape of the frame 104 (and thus, in some embodiments, the grease filter assembly 100) may be at least laterally symmetrical, such that the frame 104 may be inserted into a hood or exhaust assembly in a plurality of orientations, to provide ease of insertion. Indeed, the frame 104 may be rotationally symmetrical in at least one plane. In any event, the frame 104 is dimensioned to capture and support, preferably removably, the intake baffle assembly 120 and exhaust trap baffle assembly 150, e.g., so that the grease filter assembly 100 is insertable into, retainable in, and removable from a commercial range hood as a singular unit. In certain embodiments, one or both of the intake baffle assembly 120 and the exhaust trap baffle assembly 150 may include a coupling 108, such as hooks, or a slip joint hinge, or other hinge assembly, to selectively mechanically couple and decouple the intake baffle assembly 120 and the exhaust trap baffle assembly 150 so that they may joined together as a unit, or separated from each other, selectively.

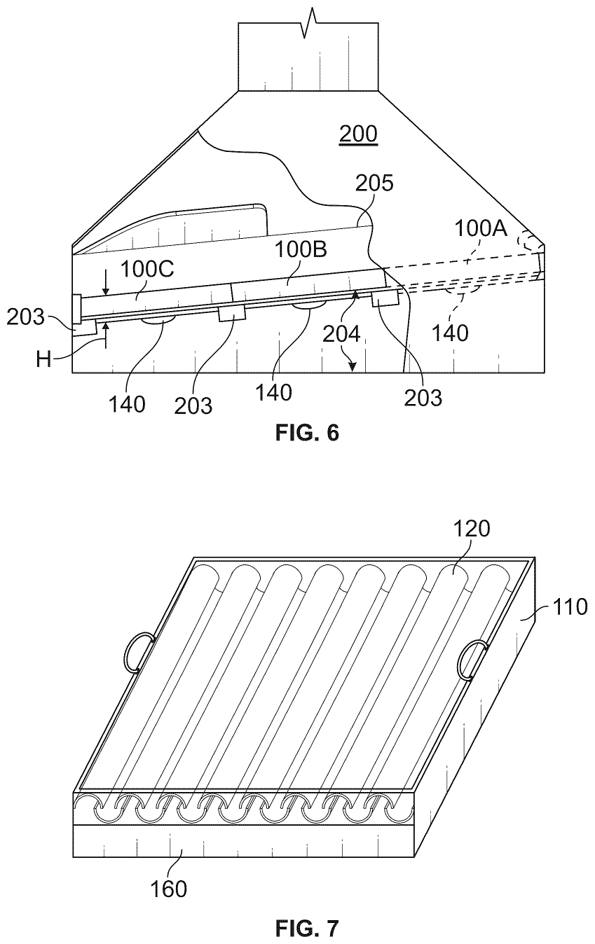

In certain embodiments, the frame 104 has length L and width W allowing for one or a whole number multiple of grease filter assemblies 100 to be received in a grease filter opening of common existing commercial range hoods. For example, the frame may have a length of 16, 20 or 24 inches and a width of 16, 20, or 24 inches for this purpose, so that one or more grease filter assemblies 100 may be received in common commercial range hood sizes. In certain embodiments, the frame 104 has a height H corresponding to the height of common existing grease filter tracks in common commercial range hoods 200, e.g., 2.0 inches, as will be best appreciated from FIGS. 3 and 6.

As mentioned above, the intake baffle assembly 120 and exhaust trap baffle assembly 150 are configured to work in tandem to direct the exhaust air through the grease filter assembly 100 in a particular manner providing highly effective grease separation (from the exhaust air) and grease capture. By way of example, certain prior art heat-exchanger based assemblies including grease-trapping baffle structures have been found to remove approximately 0%-5% of air-entrained grease. In sharp contrast, an exemplary grease filter assembly in accordance with the present invention has been found to remove more than 90%, e.g., approximately 94%-99%, of air-entrained grease.

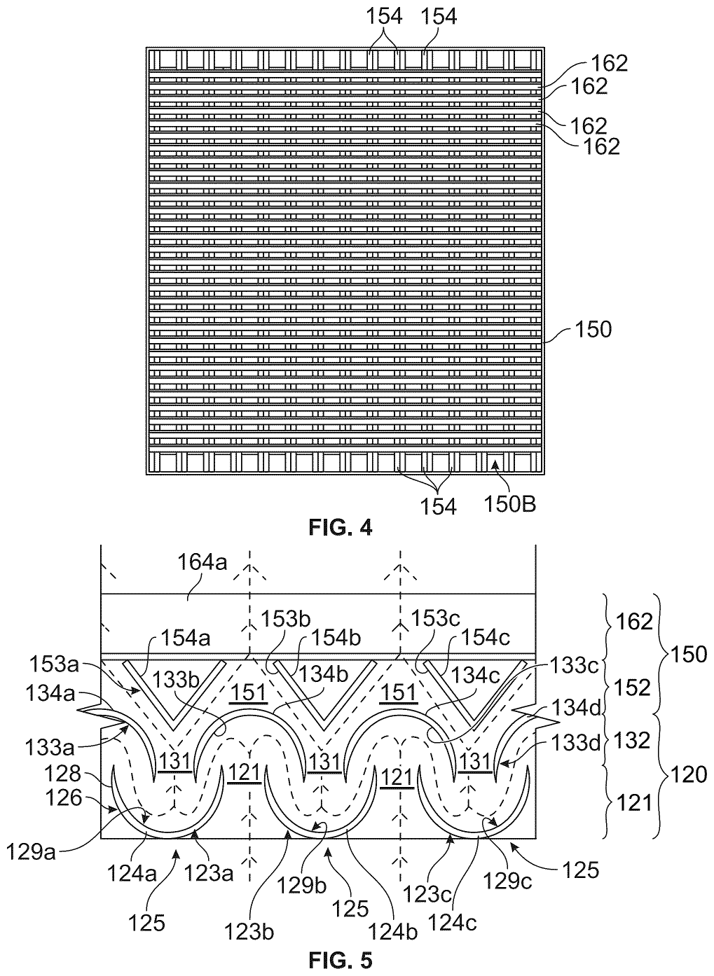

Referring now to FIGS. 3 and 5, the intake baffle assembly 120 is discussed herein greater detail. The intake baffle assembly 120 includes a first baffle array 122 and a second baffle array 132. The first baffle array 122 includes a plurality of spaced air-splitting baffles 124a, 124b, 124c, etc. that may be joined at their ends to a flange, plate or frame (not shown) to fix them together as an integral unit in a predetermined spatial arrangement relative to one another. The baffles may be positioned parallel to each other and parallel to the first sidewall 104A and the second sidewall 104B. In the illustrated embodiments, the baffles are positioned from sidewall to sidewall.

Each air-splitting baffle 124a, 124b, 124c has an outer/leading surface 123a, 123b, 123c that is generally convex in shape. In the exemplary embodiment, at each air-splitting baffle 124a, 124b, 124c defines a smooth generally-arcuate shape in cross section (see FIG. 5), and is at least in part semi-circular. In the example shown in FIG. 5, each air-splitting baffle 124a, 124b, 124c has a first portion 126 that a semi-circular cross section and further has tail portions 128 extending from the semi-circular portion of each baffle. In alternative embodiments, the baffles may be generally convex but may not be semi-circular and may not define a smooth generally-arcuate shape in cross-section. For example, the shape may be somewhat polygonal in nature (e.g., having a plurality of flat lands separated by an angle, such 150 degrees, in cross-section), such as semi-octagonal, instead of semi-circular. Generally convex shapes that are not semi-circular and do not define a smooth generally-arcuate shape in cross-section may be preferred in that they may help to create air turbulence that is helping in extracting/capturing air-entrained grease. Accordingly, each air-splitting baffle 124a, 124b, 124c is configured to direct exhaust air/air incident upon each baffle (moving upward in the orientation shown in FIG. 5) away from the central portion 125 to openings 121 defined between the spaced air-splitting baffles 124a, 124b, 124c, as will be appreciated from FIG. 5.

As noted above, the intake baffle assembly 120 includes a second baffle array 132. The second baffle array 132 includes a plurality of spaced air-redirecting baffles 134a, 134b, 134c, 134d, etc. that may be joined at their ends to a flange, plate or frame (not shown) to fix them together as an integral unit in a predetermined spatial arrangement relative to one another. The flange, plate or frame may be further configured to support the baffles of the second baffle array 132 in a predetermined spatial arrangement relative to the baffles of the first baffle array 122, when the baffles arrays are assembled to the housing 110, as discussed in further detail below.

Each air-redirecting baffle 134a, 134b, 134c, 134d has an

inner/leading surface 133a, 133b, 133c, 133d that is generally concave in shape. In the exemplary embodiment, each air-redirecting baffle 134a, 134b, 134c, 134d defines a smooth generally-arcuate shape in cross section (see FIG. 5), and is at least in part semi-circular. In the example shown in FIG. 5, each air-redirecting baffle 134a, 134b, 134c, 134d has a first portion 136 that a semi-circular cross section and further has tail portions 138 extending from the semi-circular portion of each baffle.

In alternative embodiments, the baffles may be generally concave for redirecting exhaust air but may not be semi-circular and may not define a smooth generally-arcuate shape in cross-section (similar to the air-splitting baffles described above).

Accordingly, each air-redirecting baffle 134a, 134b, 134c, 134d is configured to redirect upward-moving exhaust air incident upon each an inner/leading surface of each air-redirecting baffle 134a, 134b, 134c, 134d in a generally downward direction, toward a trailing/inner surface 129a, 129b, 129c of the air-splitting baffles 124a, 124b, 124c, as will be appreciated from FIG. 5. In accordance with the present invention, the first baffle array 122 and the second baffle array 132 are closely-spaced in the direction of air flow (e.g., upward, in FIG. 5).

In a preferred embodiment, the baffles of the baffle array 122 and baffles of the second baffle array 132 are misaligned relative to one another (e.g., 180 degrees out of phase) so that the openings 121 defined between adjacent baffles of the first baffle array 122 align with central portions of the baffles of the second baffle array, and so that openings 131 defined between adjacent baffles of the second baffle array 132 align with central portions 125 of the baffles of the first baffle array 122.

Further, in a preferred embodiment, the second baffle array 132 and the first baffle array 122 are so closely-spaced in the direction of air flow (e.g., upward, in FIG. 5), that the air-redirecting baffles 134a, 134b, 134c, 134d, etc. of the second baffle array 132 are nested within the air-splitting baffles 124a, 124b, 124c, etc. of the first baffle array 122 such portions of the baffles of the second baffle array 132 overlap with portions (e.g., tail portions 128, 138) of the first baffle array 122 in the direction of the air flow, to form a generally serpentine-shaped region therebetween.

As will be appreciated from FIG. 5, air drawn through openings 121 between the air-splitting baffles 124a, 124b, 124c, etc. of the first baffle array 122 is redirected by the air-redirecting baffles 134a, 134b, 124c, 134d, etc. back toward trailing surfaces 129a, 129b, 129c, etc. of the air-splitting baffles 124a, 124b, 124c, etc. of the first baffle array 122, and air from adjacent air redirecting baffles, e.g., 134b, 134c, meets toward a central portion 125b on the side of the trailing surface 129b of a spanning air-splitting baffle, e.g., 124b, and is caused to flow between the opening 131 between the corresponding air-redirecting baffles, e.g., 134b, 134c, as will be appreciated from FIG. 5.

The tightly-defined serpentine-shaped region defined by the first and second baffle arrays 122, 132 and/or the nesting/overlapping of the baffles is believed to cause an increase in air stream speed and a resulting pressure drop, in accordance with Bernoulli's principle and/or the Coanda effect, that greatly increases removal of grease entrained in the exhaust air as the exhaust air passes through the air intake baffle. By way of example, an airflow over a baffle member results in a downstream pressure drop immediately adjacent the downstream portion of the baffle member, according to the Coanda effect. As a result, grease tends to collect on the inner/leading surfaces 133a, 133b, 133c, 133d of the air-redirecting baffles in the second baffle array 132, and on the inner/trailing surfaces 129a, 129b, 129c of the air-splitting baffles in the first baffle array 122. Accordingly, the intake air baffle assembly 120 serves as a first stage of a multi-stage grease filtering/grease trapping arrangement of the grease filter assembly 100.

Optionally, interior and/or exterior surfaces of the air-splitting baffles and/or the air-redirecting baffles may be pitted or dimpled (somewhat like a surface of a golf ball) to further promote air turbulence that is believed to help in extracting/capturing air-entrained grease.

The exhaust trap baffle assembly 150 serves as a second stage of the multi-stage grease filtering/grease trapping arrangement of the grease filter assembly 100. More particularly, the exhaust trap baffle assembly 150 includes a diverter array 152 and a spacer array 162. The diverter array 152 includes a plurality of spaced air-diverting baffles 154a, 154b, 154c, etc. that may be joined at their ends to a flange, plate or frame (not shown) to fix them together as an integral unit in a predetermined spatial arrangement relative to one another. The baffles may be positioned parallel to each other and parallel any of the sidewalls 104A, 104B, 104C, 104D. In the illustrated embodiments, the baffles are positioned from sidewall to sidewall.

Each air-diverting baffle 154a, 154b, 154c has an outer/leading surface 153a, 153b, 153c that is generally convex in shape. In the exemplary embodiment, each air-diverting baffle 154a, 154b, 154c defines a chevron shape (e.g., a V-shape) in cross section (see FIG. 5). In alternative embodiments, the air-diverting baffles may be generally convex but may not be chevron-shaped in cross section, and may be, for example, circular, semi-circular, define a smooth generally-arcuate shape in cross-section, or simply define a generally convex shape in cross-section. Accordingly, each air-diverting baffle 154a, 154b, 154c is configured to direct exhaust air/air incident upon each baffle (moving upward in the orientation shown in FIG. 5) away from its central portion 155 to openings 151 defined between the spaced air-diverting baffles 154a, 154b, 154c, as will be appreciated from FIG. 5. The air-diverting baffles may be joined at their ends to a frame 160 to fix them together as an integral unit in a predetermined spatial arrangement relative to one another, as best shown in FIG. 3.

As noted above, the exemplary exhaust trap baffle assembly 150 includes a spacer array 162. In certain embodiments, the spacer array 162 may be omitted. The spacer array 162 includes a plurality of spacers 164a, 164b, 164c, etc. that are elongated in the direction of flow of the exhaust air (vertically as shown in in FIG. 5) so as to make the overall height of the combined intake baffle assembly and exhaust trap baffle assembly corresponding (at least at a portion of the spacers) to the height H of the housing 110, so that they fit snugly within the frame. The spacers 164a, 164b, 164c, etc. may be joined at their ends to the frame 160 to fix them together as an integral unit in a predetermined spatial arrangement relative to one another. Alternatively, or additionally, the spacers 164a, 164b, 164c, etc. may be joined at their leading edges to trailing edges of the air-diverting baffles 154a, 154b, etc., to join them together as an assembly. Optionally, the spacers 164a, 164b, 164c, etc. may extend transversely to the air-diverting baffles 154a, 154b, 154c, etc., as shown in FIGS. 2, 3, 4 and 5. The frame 160 may be further configured to support the spacers of the spacer array 162 in a predetermined spatial arrangement relative to the air-diverting baffles 154a, 154b, 154c and/or relative to the baffles of the second baffle array 132, when the baffles arrays are assembled to the housing 110.

Accordingly, each air-diverting baffle 154a, 154b, 154c, etc. is configured to split and/or divert upward-moving exhaust air flowing from the openings 151 between the air-diverting baffles 134a, 134b, 134c, etc. of the second baffle array 132 and incident upon each an outer/leading surface 153a, 153b, 153c, etc. of each air-diverting baffle 154a, 154b, 154c in a generally upward direction, as will be appreciated from FIG. 5. In accordance with the present invention, the baffles of the air-diverting baffle array 152 and the baffles 134a, 134b, 134c, etc. of the second baffle array 132 are closely-spaced in the direction of air flow (e.g., upward, in FIG. 5).

In a preferred embodiment, the baffles of the air-diverting baffle array 152 and baffles of the second baffle array 132 are misaligned relative to one another (e.g., 180 degrees out of phase) so that the openings 151 defined between adjacent baffles of the second baffle array 132 align with central portions of the baffles of the air-diverting baffle array 152.

Further, in a preferred embodiment, the air-diverting baffle array 152 and the second baffle array 132 are so closely-spaced in the direction of air flow (e.g., upward, in FIG. 5), that the air-diverting baffles 154a, 154b, 154c, 154d, etc. of the air-diverting baffle array 152 are nested between the air-redirecting baffles 134a, 134b, 134c, etc. of the second baffle array 132 such portions of their baffles overlap in the direction of the air flow.

As will be appreciated from FIG. 5, air drawn through openings 131 between the air-redirecting baffles 134a, 134b, 134c, 134d, etc. of the second baffle array 132 is split/diverted by the air-diverting baffles 154a, 154b, 154c, etc. and cause to flow through openings 151, and to pass between adjacent spacers 162a, 162b, etc. of the spacer array 162, and to exit the grease filter assembly 100, as will be appreciated from FIGS. 3, 5 and 6.

The region defined between the second baffle array 132 and the air-diverting baffle array 152 and/or the nesting/overlapping of the baffles is believed to cause an increase in air stream speed and a resulting a pressure drop, in accordance with Bernoulli's principle and/or the Coanda effect, that greatly increases removal of grease entrained in the exhaust air as the exhaust air passes through the air exhaust baffle 150. As a result, grease tends to collect on the outer/trailing surfaces 135a, 135b, 135c, 135d of the air-redirecting baffles in the second baffle array 132, and on the outer/leading surfaces 153a, 153b, 153c of the air-diverting baffles in the air-diverting baffle array 152. Additionally, grease tends to collect on the spacers 162a, 162b, etc. of the spacer array 162 as a result of air passing between the spacers. Accordingly, the exhaust air baffle assembly 150 serves as a second stage of a multi-stage grease filtering/grease trapping arrangement of the grease filter assembly 100.

Optionally, interior and/or exterior surfaces of the air-diverting baffles may be pitted or dimpled (somewhat like a surface of a golf ball) to further promote air turbulence that is believed to help in extracting/capturing air-entrained grease.

As a result of the typical generally upright orientation of the grease filter assembly 100 when installed in a commercial range hood, grease collected on the spacers of the spacer array 162 and on the outer/leading surfaces 153a, 153b, 153c of the air-diverting baffles in the air-diverting baffle array 152 tends to drain downwardly and drip onto the opposed outer/trailing surfaces 135a, 135b, 135c, 135d of the air-redirecting baffles 134a, 134b, 134c, 134d and/or into the inner/trailing surfaces 129a, 129b, 129c of the air-splitting baffles in the first baffle array 122, as the result of gravity.

Additionally, grease collected on the inner/leading surfaces 133a, 133b, 133c, 133d of the air-redirecting baffles in the second baffle array 132 tends to drain downwardly and drip onto the opposed inner/trailing surfaces 129a, 129b, 129c of the air-splitting baffles in the first baffle array 122, as the result of gravity. Further, as a result of the typical tilted (non-horizontal) orientation of the grease filter assembly 100 when installed in a commercial range hood, grease collected on the inner/trailing surfaces 129a, 129b, 129c of the air-splitting baffles in the first baffle array 122 tends to drain toward a lower end of the baffles of the first baffle array 122, as the result of gravity. This facilitates collection of grease from the baffles in a suitable pan, catch can, or other receptacle, such as a track that is part of the hood assembly. The filter assembly may have discrete openings 112 in the housing 110 (FIG. 3) and/or otherwise be open at the front half of the bottom of the baffle section (FIG. 7) to allow the grease to drain into the track, and collection of the grease may be performed by built in grease cups of the hood assembly, as is known in the art.

In some embodiments, portions of the housing 110, intake baffle assembly 120 and/or exhaust trap baffle assembly 150 may be coated to prevent grease build-up and/or draining of grease from the grease filter assembly 100 as described above. For example, portions of the grease filter assembly 100 may be coated with an environmentally-friendly non-stick coating for this purpose.

Referring now to FIG. 6, it will be appreciated that the grease filter assembly of the present invention collects grease generated by food cooking activities that would otherwise be exhausted into the environment. As shown in FIG. 6, one or more grease filter assemblies 100A, 100B, 100C may be installed into an exhaust housing 200 above a cooking surface. Although the grease filter assembly 100 could be installed at any desirable angle, such as horizontal, some embodiments include a filter 100 installed at an angle 204 relative to horizontal plane, as shown in FIG. 6. In certain embodiments, the angle 204 may be between about 12 degrees to about 45 degrees to allow collected grease/particles to drain. In this configuration, collected particles will drain from drain holes (not shown) and into one or more grease traps 203. As further shown in FIG. 6, a plurality of filter units 100 may be coupled together to form an expanded filter unit.

In the illustrated embodiment, the grease filter assemblies 100A, 100B, 100C are positioned such that the exhaust air enters a first side 190 of the grease filter assemblies 100A, 100B, 100C. Accordingly, the intake air baffle array 122 is positioned adjacent the first side 190, such that the air intake baffle arrays 122 are positioned at an inlet of the airflow into the grease filter assemblies, with the exhaust air flowing into each grease filter assembly first contacts/bypasses the intake air baffle array 122, as will be appreciated from FIGS. 1, 5 and 6. It will be appreciated that each baffle may be any shape or size and each baffle may be a different shape and/or size than another baffle.

In a preferred embodiment, the intake air baffle array, the exhaust baffle array 132, the diverter array 152, and the spacer array 162 may be constructed to be separable from one another, to allow them to be separated from each other and/or the housing 110 for cleaning purposes, and to facilitate cleaning, reassembly, and re-use of the filter assembly 100. In certain embodiments, the intake baffle array and the exhaust baffle array may be interconnected as a unit.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A grease filter assembly comprising:
a housing defining a frame;
an intake baffle assembly supported on the housing within the frame and positionable at an inlet of an airflow, said intake baffle assembly comprising:
a first baffle array comprising a plurality of air-splitting baffles, each of said plurality of air-splitting baffles being convex in cross-section, said plurality of air-splitting baffles being supported in a spaced arrangement; and
a second baffle array comprising a plurality of air-redirecting baffles, each of said plurality of air-redirecting baffles being concave in cross-section, said plurality of air-redirecting baffles being supported in a spaced arrangement; and
an exhaust trap baffle assembly supported on said housing adjacent said intake baffle assembly within said frame and positioned at an outlet of the airflow;
wherein the one or more baffles directs the airflow from a first side, through the grease filter assembly, to a second side.

2. The grease filter assembly of claim 1, wherein said plurality of air-redirecting baffles of said second baffle array are so closely-spaced in a direction of air flow through the grease filter assembly that each of said plurality of air-redirecting baffles of said second baffle array is nested within respective ones of aid plurality of air-splitting baffles of said first baffle assembly that portions of baffles of said second baffle array overlap in the direction of air flow with portions of baffles of said first baffle array to define a generally serpentine-shaped region therebetween.

3. The grease filter assembly of claim 1, wherein each air-splitting baffle defines a smooth arcuate shape in cross section.

4. The grease filter assembly of claim 3, wherein each air-splitting baffle is at least in part semi-circular in cross-section.

5. The grease filter assembly of claim 4, wherein each air-splitting baffle has a first portion that is semi-circular cross section and tail portions extending from the first portion of each baffle.

6. The grease filter assembly of claim 1, wherein each air-splitting baffle is at least in part semi-polygonal in cross-section.

7. The grease filter assembly of claim 1, wherein each air-redirecting baffle defines a smooth arcuate shape in cross section.

8. The grease filter assembly of claim 7, wherein each air-redirecting baffle is at least in part semi-circular in cross-section.

9. The grease filter assembly of claim 8, wherein each air-redirecting baffle has a first portion that is semi-circular cross section and tail portions extending from the first portion of each baffle.

10. The grease filter assembly of claim 1, wherein each air-redirecting baffle is at least in part semi-polygonal in cross-section.

11. The grease filter assembly of claim 1, wherein said intake baffle assembly comprises a first row of air-intake baffles facing a first side of said housing and a second row of air-redirecting baffles facing an opposite side of said housing, opposite said first row, said first row of air-intake baffles and said second row of air-diverting baffles being laterally misaligned.

12. The grease filter assembly of claim 1, further comprising:
a pair of opposed handles supported on said housing.

13. The grease filter assembly of claim 1, wherein a surface of each of said baffles defines one of a plurality of dimples and a plurality of pits to promote turbulence of an airflow adjacent said surface.

14. The grease filter assembly of claim 1, wherein said exhaust baffle assembly comprises:
a diverter array comprising a plurality of air-diverting baffles, each of said plurality of air-diverting baffles being convex in cross-section, said plurality of air-diverting baffles being supported in a spaced arrangement; and
a spacer array comprising a plurality of spacers, each of said plurality of spacers being elongated in the direction of air flow through the grease filter assembly, said plurality of spacers being supported in a spaced arrangement.

15. The grease filter assembly of claim 14, wherein each air-diverting baffle defines a smooth arcuate shape in cross section.

16. The grease filter assembly of claim 15, wherein each air-diverting baffle is at least in part semi-circular in cross-section.

17. The grease filter assembly of claim 4, wherein each air-diverting baffle has a first portion that is semi-circular cross section and tail portions extending from the first portion of each baffle.

18. The grease filter assembly of claim 14, wherein each air-diverting baffle defines a chevron shape in cross section.

19. The grease filter assembly of claim 14, wherein said plurality of air-diverting baffles of said diverter array are so closely-spaced in a direction of air flow through the grease filter assembly that each of said plurality of air-diverting baffles of said diverter array is closely spaced with and nested between respective ones of said plurality of air-redirecting baffles of said second baffle assembly such that they overlap in the direction of air flow.

20. The grease filter assembly of claim 1, wherein at least one of said first baffle array and second baffle array comprises a coupling for selectively mechanically coupling and mechanically decoupling said second baffle array to said first baffle array.

21. A grease filter assembly comprising:
a housing defining a frame;
an intake baffle assembly supported on the housing within the frame, said intake baffle assembly comprising:
a first baffle array comprising a plurality of air-splitting baffles, each of said plurality of air-splitting baffles being convex in cross-section, said plurality of air-splitting baffles being supported in a spaced arrangement; and
a second baffle array comprising a plurality of air-redirecting baffles, each of said plurality of air-redirecting baffles being concave in cross-section, said plurality of air-redirecting baffles being supported in a spaced arrangement; and
an exhaust trap baffle assembly supported on said housing adjacent said intake baffle assembly within said frame and positioned at an outlet of the airflow, said exhaust baffle assembly comprising:
a diverter array comprising a plurality of air-diverting baffles, each of said plurality of air-diverting baffles being convex in cross-section, said plurality of air-diverting baffles being supported in a spaced arrangement; and
a spacer array comprising a plurality of spacers, each of said plurality of spacers being elongated in the direction of air flow through the grease filter assembly, said plurality of spacers being supported in a spaced arrangement;
wherein baffles of said intake baffle assembly and said exhaust trap baffle assembly direct airflow from a first side, through the grease filter assembly, to a second side, when in use to extract grease from the airflow.

22. The grease filter assembly of claim 21, wherein said plurality of air-redirecting baffles of said second baffle array are so closely-spaced in a direction of air flow through the grease filter assembly that each of said plurality of air-redirecting baffles of said second baffle array is nested within respective ones of aid plurality of air-splitting baffles of said first baffle assembly that portions of baffles of said second baffle array overlap in the direction of air flow with portions of baffles of said first baffle array to define a generally serpentine-shaped region therebetween.

23. The grease filter assembly of claim 21, wherein each air-splitting baffle defines a smooth arcuate shape in cross section.

24. The grease filter assembly of claim 23, wherein each air-splitting baffle is at least in part semi-circular in cross-section.

25. The grease filter assembly of claim 24, wherein each air-splitting baffle has a first portion that is semi-circular cross section and tail portions extending from the first portion of each baffle.

26. The grease filter assembly of claim 21, wherein each air-splitting baffle is at least in part semi-polygonal in cross-section.

27. The grease filter assembly of claim 21, wherein each air-redirecting baffle defines a smooth arcuate shape in cross section.

28. The grease filter assembly of claim 27, wherein each air-redirecting baffle is at least in part semi-circular in cross-section.

29. The grease filter assembly of claim 28, wherein each air-redirecting baffle has a first portion that is semi-circular cross section and tail portions extending from the first portion of each baffle.

30. The grease filter assembly of claim 21, wherein each air-redirecting baffle is at least in part semi-polygonal in cross-section.

31. The grease filter assembly of claim 21, wherein said intake baffle assembly comprises a first row of air-intake baffles facing a first side of said housing and a second row of air-redirecting baffles facing an opposite side of said housing, opposite said first row, said first row of air-intake baffles and said second row of air-diverting baffles being laterally misaligned.

32. The grease filter assembly of claim 21, further comprising:
a pair of opposed handles supported on said housing.

33. The grease filter assembly of claim 21, wherein a surface of each of said baffles defines one of a plurality of dimples and a plurality of pits to promote turbulence of an airflow adjacent said surface.

34. The grease filter assembly of claim 21, wherein each air-diverting baffle defines a smooth arcuate shape in cross section.

35. The grease filter assembly of claim 34, wherein each air-diverting baffle is at least in part semi-circular in cross-section.

36. The grease filter assembly of claim 34, wherein each air-diverting baffle has a first portion that is semi-circular cross section and tail portions extending from the first portion of each baffle.

37. The grease filter assembly of claim 21, wherein each air-diverting baffle defines a chevron shape in cross section.

38. The grease filter assembly of claim 21, wherein said plurality of air-diverting baffles of said diverter array are so closely-spaced in a direction of air flow through the grease filter assembly that each of said plurality of air-diverting baffles of said diverter array is closely spaced with and nested between respective ones of said plurality of air-redirecting baffles of said second baffle assembly such that they overlap in the direction of air flow.

39. The grease filter assembly of claim 21, wherein at least one of said first baffle array and second baffle array comprises a coupling for selectively mechanically coupling and mechanically decoupling said second baffle array to said first baffle array.
